(19) United States
(12) Patent Application Publication
(10) Pub. No.: US 2019/0243007 A1
(43) Pub. Date: Aug. 8, 2019

(54) Radiation Detectors

(71) Applicant: RAPISCAN SYSTEMS LIMITED, Radlett, Hertfordshire (GB)

(72) Inventors: Timothy Martin COKER, Maidstone (GB); Russell David LUGGAR, Dorking (GB); Paul DE ANTONIS, Horsham (GB); Tiago PIRES DA SILVA MASCARENHAS DE MENEZES, London (GB)

(73) Assignee: Rapiscan Systems Limited, Radlett, Hertfordshire (GB)

(21) Appl. No.: 14/903,112

(22) PCT Filed: Jul. 10, 2014
(86) PCT No.: PCT/GB2014/052110

§ 371 Date: Jun. 1, 2016

(30) Foreign Application Priority Data
Jul. 10, 2013 (GB) 1312352.6

(51) Int. Cl. G01T 1/20; G01T 1/202

(52) U.S. Cl. CPC G01T 1/2002; G01T 1/2023; G01T 1/2006

(57) ABSTRACT

A radiation detector includes a scintillator block 10 comprising scintillator material and a coating 12 of reflective material applied to the surface of the scintillator block, wherein the reflective material is a composite material comprising a matrix and particles supported in the matrix, wherein the matrix comprises at least one of: silicone, polyurethane, polyester, acrylic, or glass.

### CROSS-REFERENCE

The present specification is a 371 National Stage application of PCT/GB2014/052110, of the same title and filed on Jul. 10, 2014, which relies on GB Patent Application Number 1312352.6, filed on Jul. 10, 2013, for priority.

### FIELD OF THE INVENTION

The present invention relates to radiation detectors, and in particular scintillation detectors, for example for use in X-ray scanners.

### BACKGROUND TO THE INVENTION

Scintillation detectors can be used individually to detect radiation in a small volume, but are often used in arrays, for example in X-ray imaging systems. A single detector typically comprises a block of scintillator material with a photodetector arranged to receive light emitted from one side of the scintillator block, and reflective material coating on one or more of the other sides of the block to prevent light escaping and reflect it back towards the photodetector. The reflective coating is generally formed of titanium dioxide particles in a matrix of some sort, which supports the titanium dioxide and helps to adhere it to the surface of the scintillator block. Where an array of detector elements is formed, a glue of some sort, typically epoxy, is also used to hold the scintillator blocks together. However, such detectors and arrays have been found to lose signal output over time when subjected to high levels of radiation, for example when used in real time tomography (RTT) machines, where they can be subjected to several tens of Mrad of radiation.

There is therefore a need for a detector, for x-rays or other radiation, which maintains its performance over long periods under high radiation levels.

### SUMMARY OF THE INVENTION

We have shown that the underlying cause of this problem is that the epoxy used to glue arrays together in prior art detectors “ages” considerably under irradiation with x-rays. This has the effect of reducing the reflectance of the detector pixels and this has the consequence that the signal output from the detector/array is a strongly decreasing function of dose.

The aging of epoxy is believed to be for the following reason. The cured epoxy polymer consists in large part of saturated carbon chains, whether these are in side groups or part of the epoxy polymer back-bone. These saturated polymer chains are electrically non-conducting up into optical frequencies and hence the solid epoxy is lossless to light transmission and appears colourless. On exposure to ionising radiation, the carbon backbone loses hydrogen and becomes unsaturated. The resulting double bonds between carbon atoms in the backbone results in electron delocalisation along the carbon chain. In effect the electrons are free to move along the carbon chain in response to an applied electric field (i.e. light). This renders the epoxy a lossy medium for the passage of light and hence absorption occurs.

According to a first aspect of the invention there is provided a radiation detector comprising a block of scintillator material and a coating of reflective material applied to the surface of the scintillator material, wherein the reflective material is a composite material comprising a matrix and particles supported in the matrix, wherein the matrix comprises at least one of: silicone, polyurethane, polyester, acrylic, or glass.

In order to cause sufficient reflection, the particles may have a refractive index (at the wavelength of the scintillation light from scintillator) that is different from, and generally greater than, the refractive index of the matrix material (at that wavelength) by at least 0.7.

The particles may comprise titanium dioxide, diamond, zirconium dioxide, zinc sulphide, barium sulphate or another suitable high refractive index material that is transparent to the scintillated radiation.

The wavelength region of interest will be the wavelength of scintillation of the scintillator used, and will therefore depend on the scintillator used. It may be a visible wavelength.

The particles may have a particle size substantially in the range 200-500 nm.

The fraction by volume of the dispersed component(s) to the matrix component(s) may be 8 to 30%.

The matrix component may comprise a liquid phase material that will solidify under certain circumstances that can be controlled, for example, the application of heat, exposure to UV radiation, mixing with a hardener.

In some circumstances it is not necessary to totally eliminate the epoxy. For example if the proportion of epoxy in the matrix is reduced, then the benefits of using an epoxy can be retained whilst the effects of aged epoxy can be reduced to a level that is acceptable.

Therefore, according to a second aspect of the invention there is provided a radiation detector comprising a block of scintillator material and a coating of reflective material applied to the surface of the scintillator material, wherein the reflective material is a composite material comprising an epoxy matrix, particles supported in the matrix, and a filler material.

In order to cause sufficient reflection, the particles may have a refractive index (at the wavelength of the scintillation from scintillator) that is different from, and generally greater than, the refractive index of the matrix material (at that wavelength) by at least 0.7.

The particles may comprise titanium dioxide, diamond, zirconium dioxide, zinc sulphide, barium sulphate or another suitable high refractive index material that is transparent to the scintillated radiation.

The filler material preferably has a refractive index that is different from the epoxy matrix by no more than 0.2, and preferably no more than 0.1.

When considering the percentage by volume of filler in the composite material, and taking the example of epoxy as the matrix component, then the maximum ratio of dry material (i.e. filler plus TiO₂) to epoxy is substantially equal to 26% by volume, of which 8 percentage points should preferably be TiO₂ to maintain optimum reflectance.

However with more than 20% per cent by volume of TiO₂ on its own the mixture tends to become too viscous to work, therefore, assuming the maximum ratio of dry material to epoxy, the filler should make up at least 6% by volume and preferably no more than 18% by volume.

Previous embodiments have addressed the problem with aging epoxy by either eliminating or reducing the amount of epoxy in the reflective material. A further approach is to use an additional material that converts the shorter wavelength scintillation light to a different wavelength (typically longer) that is not absorbed to the same extent by the aged epoxy.

According to a further aspect of the invention, therefore, there is provided a radiation detector comprising a block of scintillator material and a coating of reflective material applied to the surface of the scintillator material, wherein the reflective material is a composite material comprising a matrix, particles supported in the matrix, and a wavelength conversion material arranged to convert light emitted by the scintillator material to light of a different wavelength.

The wavelength conversion material may be arranged to convert the light to light of a longer wavelength, for example a longer wavelength within the visible spectrum. For example the scintillation material may be LYSO and the wavelength conversion material may be cerium doped yttrium aluminium garnet (Ce:YAG). This would absorb the LYSO emission (where the peak wavelength of emission, λmax, is 420 nm) and re-emit at 550 nm with a decay time of 70 ns.

Whilst the effect of the epoxy can be reduced or eliminated by the methods described above, there is an additional technique that is applicable to the manufacture of arrays of detectors where a glue of some sort is required to mechanically hold the individual detectors together. In prior art arrays the glue is typically an epoxy and forms the matrix of the reflective material, but this clearly suffers the problem of ageing epoxy. However, by keeping the epoxy separate from the reflective material, the benefits of epoxy can be retained without the problems.

Therefore according to a yet further aspect of the invention there is provided a radiation detector array comprising a plurality of blocks of scintillator material arranged in an array, each block having a coating of reflective material applied to its surface, and a barrier layer applied on top of the reflective material, wherein adhesive is provided between the barrier layers of adjacent blocks to retain the blocks together in the array, whereby the barrier layer acts so as to prevent the adhesive coming into direct contact with the reflective material.

The reflective material, as previously described, preferably has a non-epoxy matrix. The barrier layer prevents the adhesive, which may be epoxy, from migrating by capillary action (or other process) into the reflective material. As the reflective coating is substantially non-transmissive, no light is transmitted through the reflective layer into the epoxy and therefore the effect of aging in the epoxy has no actual effect on the radiation detector.

The detector may comprise, in any combination, any one or more features of the preferred embodiments which will now be described by way of example only with reference to the accompanying drawings.

### BRIEF DESCRIPTION OF THE DRAWINGS

FIG. 1 is a schematic view of a detector element according to an embodiment of the invention;

FIG. 2 is a schematic front view of a detector array according to an embodiment of the invention;

FIG. 3 is a schematic section through the detector array of FIG. 2; and

FIG. 4 is schematic partial section through detector array according to a further embodiment of the invention.

### DETAILED DESCRIPTION

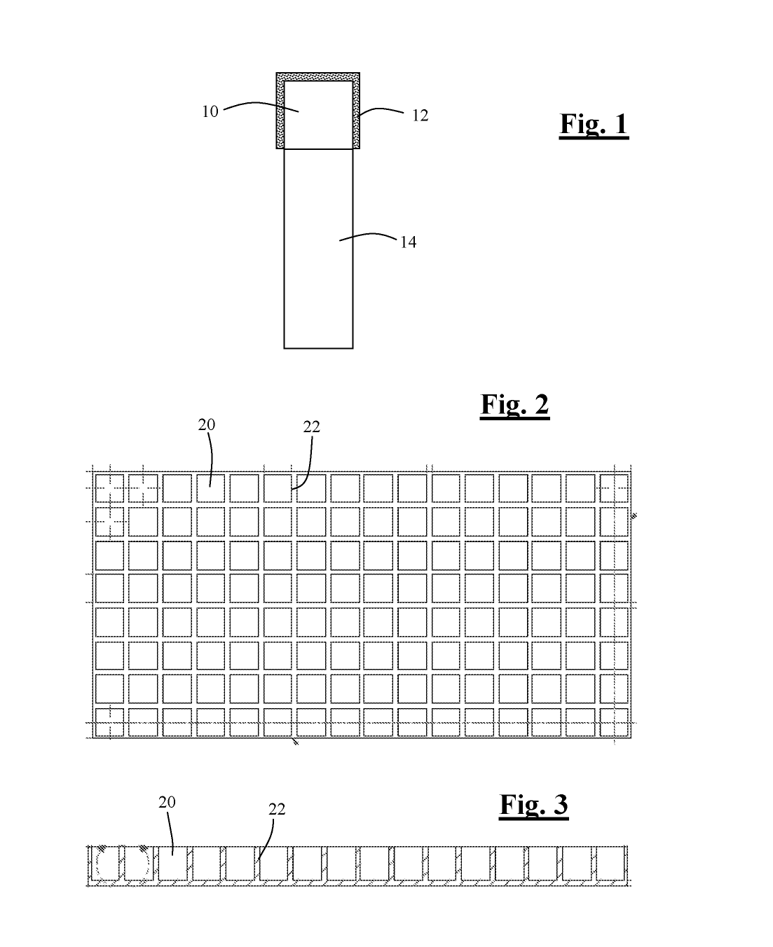

Referring to FIG. 1, an x-ray detector according to one embodiment of the invention comprises a block 10 of a scintillator material, typically about 2 mm wide, with a layer of reflective material 12 coating five of its six sides. On the un-coated side of the scintillator block a photodetector 14 is arranged to receive radiation emitted from the scintillator block. In this case the scintillator material is LYSO, but other scintillators such as Cadmium Tungstate (Cd WO), LSO, Caesium Iodide etc. can also be used. The reflective material 12 comprises particles of a reflector material supported in a matrix. The particles are titanium dioxide, with a particle size of 200 to 500 nm, and the matrix material is a silicone.

As is well known, silicones are a group of materials which contain the ‘siloxy group’ (O—Si—O). Such materials can be solids, liquids or gases at ambient. The siloxy group can form polymeric solids in chemical combination with variable amounts of organic hydrocarbon polymers. If there are no additional organics to the siloxy polymer, one has pure silica, a refractory hard ceramic/glass. Increasing the amount of additional organic polymers leads to more elastic materials suitable for use as the matrix material. Specific silicones that have been found effective in this invention include Sylgard 184 (Dow Corning); R21A28 (NUSIL); and CF2-4721 (NUSIL). It is believed that the essential part of the silicone's resistance to yellowing is due to the siloxy (O—Si—O) group interrupting the long contiguous chains present in this polymeric backbone. In effect the siloxy groups constrain electron delocalisation to numerous isolated islands along the chain. Hence the ability of the delocalised electrons to couple to the electric vector of incoming light is limited and absorption remains minimal.

The concentration of the particle material can be selected appropriately. The percentage volume concentration (PVC) of TiO₂ (for 200 nm spherical particles) reaches its maximum effectiveness of reflecting light at about 30%. This equates to a mass percentage of ˜63% with organic binders such as silicone. Mechanically, however, uncured binder/TiO₂ mixtures are unworkable above 50% TiO₂ by mass content which equate to a PVC of 20%. A minimum PVC of 8% is required to obtain sufficient reflection.

Manufacture of the detector is performed in conventional manner, but with the reflective material 12 described above being used instead of the conventional epoxy-based matrix. Specifically the scintillator 10 is cut to size, its surfaces may be polished, and then the reflective material is applied on at least one, but not all, sides to keep the scintillation light from escaping in unwanted directions.

Referring to FIGS. 2 and 3, a detector array according to a second embodiment of the invention comprises a regular rectangular array of scintillator blocks 20 all supported in reflective material 22. The reflective material 22 encases the scintillator blocks 20 on five sides, forming a continuous layer 26 on one side of them, and filling the gaps 28 between them. The reflective material 22 therefore coats five out of six sides of each of the scintillator blocks 20, leaving one side exposed for the photodetectors (not shown). In this embodiment the scintillator blocks 20 and the reflective material 22 are the same as in the embodiment of FIG. 1.

This array of detector elements can be formed in a number of ways. For example the scintillator can be provided as a single large block, a rectangular grid of grooves cut into the block, extending most but not all the way through the block leaving a solid sheet on one side of the block and a rectangular array of rectangular projections extending up from that sheet on the other side which will form the individual blocks 20. The reflective material can then be placed into the grooves to fill them, and also to cover the top faces of the projections to form the continuous layer of reflective material. The solid sheet of scintillator material is then ground off, to leave the structure of FIGS. 2 and 3.

In other embodiments, the composite reflective material is made up of different components. As mentioned above, other matrix materials can be polyester, polyurethane, or glass. Polyester and polyurethane, and indeed other aromatic polymers, have been found not to age on exposure to high radiation doses. Glasses, are non-crystalline inorganic solids, the atoms in glass have no long range ordering akin to a liquid phase but with frozen atomic positions. Glasses are characterised by having no fixed melting point but only a seamless increase in viscosity tending to infinity on cooling from the melt. The working point temperature of a glass is that temperature at which flow can usefully occur to allow fabrication. The glass matrix is covalently bound but can have metal ions intercalated into this structure. Often such ions are mobile. Glasses are formed by oxides of silicon, phosphorus and boron, or mixtures of these with other metal oxides to form silicates, phosphates and borates. Lead oxide forms a series of glasses with silica and/or boron oxide (plus other metal oxides) to form solder glasses which are characterised by their exceptionally low working point temperature (˜500K). Certain metal ions are rendered optically active when ionised by x-rays leading to optical absorption. The glass needs to be purified, to remove these metals as impurities (e.g. Fe) to less than 20 ppm to provide radiation resistance.

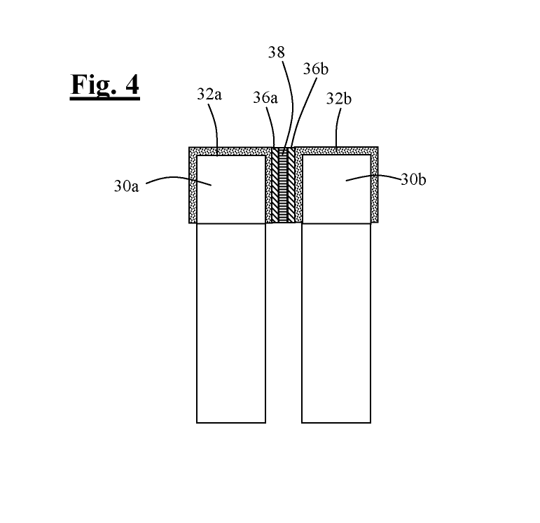

Referring to FIG. 4, in a further embodiment of the invention, an array of detectors is made up of a number of individual detectors each being as described above with reference to FIG. 1, and comprising a scintillator block 30a, 30b, with reflective coating 32a, 32b on all but one surface. However, each pair of adjacent scintillator blocks is glued together with a layer of epoxy glue 38. In order to prevent the epoxy from affecting the reflectivity of the reflective coating 32a, 32b, a barrier layer, for example of polymethyl acrylic resin applied as a water based dispersion is provided between the reflective coating and the epoxy glue layer. This prevents the epoxy, and its hardener which may be a volatile amine hardener, from penetrating into the reflective coating, which would otherwise result in degradation of the reflectivity of the coating. Other barrier layers can comprise sodium silicate applied as a water based solution which is allowed to dry thoroughly before gluing.

In the embodiments described above, the problem of the effects of radiation on epoxy is overcome by using suitably selected alternative compositions as the matrix material. However, in a further group of embodiments, epoxy is used as the matrix material in the reflective coating, but the fraction by volume of the epoxy is low enough that the effect of aging within the epoxy is small enough for its intended application. This fraction by volume can be lowered by using an additional dispersed component, in addition to the epoxy and the particulate material such as titanium dioxide. This additional dispersed, or filler, component may have a refractive index closer to that of the matrix than the other dispersed components.

For example, in one embodiment, titanium dioxide is used as the particulate reflecting component, epoxy is used as the matrix material and silicon dioxide is used as a filler. Silicon dioxide has a similar refractive index to epoxy, and so is optically neutral in this composite material. The combination of epoxy and titanium dioxide provides the level of reflection required. However, because of the relatively low fraction of epoxy, any decay of the epoxy has a relatively small effect on the reflectivity of the composite as a whole, so it has a relatively long lifetime compared to conventional epoxy composites. However, the titanium dioxide, or other particulate component at a 200 nm particle size, still needs to make up at least 8% by volume of the composite. The minimum amount of epoxy needed as the matrix material is generally at least 70% by volume, although for small filler particles, about 80% by volume of epoxy may be required and preferably at least 90% by volume. However, the amount used is a compromise between reducing the epoxy to reduce the yellowing effect, and not reducing it too far which results in the mixture becoming too viscous to dispense.

According to a further embodiment of the invention, the scintillation material is again LYSO, and the wavelength conversion material comprises a matrix of epoxy, reflecting particles, again in the form of titanium dioxide, and particles of a wavelength conversion material, in this case cerium doped yttrium aluminium garnet (Ce:YAG). The Ce:YAG shifts the wavelength of the light from the LYSO from the blue region of the spectrum where it is emitted (specifically at λmax=420 nm), to the yellow region (specifically 550 nm with a decay time of 70 ns). Other wavelength converters that are arranged to convert the light to light of a longer wavelength, for example a longer wavelength within the visible spectrum, and also be used. However it is important that the wavelength conversion material should have as short a decay time as possible so as not to add delay to the detection process. Therefore the wavelength conversion material should fluoresce not phosphoresce. The advantage of this embodiment is that as the epoxy ages, it's reflectivity at longer, yellow wavelengths is not degraded as much as at higher blue wavelengths (hence its yellowing in appearance). Therefore shifting the scintillated light towards the longer wavelength, in this case yellow, part of the spectrum means that it is less affected by the degrading of the epoxy, and so the loss of light in the reflective coating is reduced.

It will be appreciated that other combinations of scintillator and wavelength converter materials would also work.

1. A radiation detector comprising:
a scintillator block comprising scintillator material and a coating of reflective material applied to a surface of the scintillator block, wherein the reflective material is a composite material comprising a matrix and particles supported in the matrix and wherein the matrix comprises at least one of: silicone, polyurethane, polyester, acrylic, or glass.

2. A radiation detector according to claim 1 wherein said scintillator material has a wavelength of scintillation, wherein the matrix material has a refractive index, and wherein the particles have a refractive index at the wavelength of the scintillation that is different from the refractive index of the matrix material by at least 0.7.

3. A radiation detector according to claim 1 wherein the particles comprise at least one of titanium dioxide, diamond, zirconium dioxide, zinc sulphide, and barium sulphate.

4. A radiation detector comprising:
a scintillator block comprising scintillator material and a coating of reflective material applied to a surface of the scintillator block, wherein the reflective material is a composite material comprising an epoxy matrix, particles supported in the matrix, and a filler material.

5. A radiation detector according to claim 4 wherein said scintillator material has a wavelength of scintillation, wherein the matrix material has a refractive index, and wherein the particles have a refractive index at the wavelength of the scintillation from the scintillator material that is different from the refractive index of the matrix material by at least 0.7.

6. A radiation detector according to claim 4 wherein the filler material has a refractive index that is different from the epoxy matrix by no more than 0.2.

7. A radiation detector array comprising:
an array of detectors according to claim 1;
adhesive between adjacent detectors in the array to hold them in place; and
a barrier layer between the adhesive and the reflective material in each of the detectors, wherein the barrier layer is configured to prevent direct physical contact between the adhesive and the reflective material.

8. An array according to claim 7 wherein the adhesive at least partly comprises epoxy.

9. An array according to claim 7, wherein the barrier layer comprises at least one of polymethyl acrylic resin and sodium silicate.

10. A radiation detector comprising:
a block comprising scintillator material and a coating of reflective material applied to a surface of the scintillator material, wherein the reflective material is a composite material comprising a matrix, particles supported in the matrix, and a wavelength conversion material configured to convert light emitted by the scintillator material to light of a different wavelength.

11. A radiation detector according to claim 10 wherein the wavelength conversion material is adapted to convert the light emitted by the scintillator material to light of a longer wavelength.

12. A radiation detector according to claim 10 wherein the scintillation material is LYSO and the wavelength conversion material is cerium doped yttrium aluminium garnet (Ce:YAG).

13. A radiation detector array comprising:
a plurality of blocks of scintillator material arranged in an array, wherein each block has a coating of reflective material applied to its surface, and a barrier layer on top of the reflective material, wherein adhesive is provided between the barrier layers of adjacent blocks to retain the adjacent blocks together in the array, and wherein the barrier layer is configured to prevent the adhesive from coming into direct contact with the reflective material.

14. An array according to claim 13 wherein the adhesive at least partly comprises epoxy.

15. An array according to claim 13 wherein the barrier layer comprises at least one of polymethyl acrylic resin and sodium silicate.

16. An array according to claim 13 wherein the reflective material is a composite material comprising a matrix and particles supported in the matrix and wherein the matrix comprises at least one of: silicone, polyurethane, polyester, acrylic, or glass.

17. An array according to claim 16 wherein said scintillator material has a wavelength of scintillation, wherein the matrix material has a refractive index, and wherein the particles have a refractive index at the wavelength of the scintillation that is different from the refractive index of the matrix material by at least 0.7.

18. An array according to claim 16 wherein the particles comprise at least one of titanium dioxide, diamond, zirconium dioxide, zinc sulphide, and barium sulphate.

19. An array according to claim 13 wherein the reflective material is a composite material comprising an epoxy matrix, particles supported in the matrix, and a filler material.

20. An array according to claim 19 wherein said scintillator material has a wavelength of scintillation, wherein the matrix material has a refractive index, and wherein the particles have a refractive index at the wavelength of the scintillation from the scintillator material that is different from the refractive index of the matrix material by at least 0.7.
